(19) United States
(12) Patent Application Publication
(10) Pub. No.: US 2024/0114077 A1
(43) Pub. Date: Apr. 4, 2024

(54) SYSTEM AND METHOD OF ASSIGNING COMMUNITY PROMOTING ROLES IN A VIRTUAL COMPUTER NETWORK OF USERS

(71) Applicant: Pocoz Israel Ltd., Even Yehuda (IL)

(72) Inventors: Tal SHEFFER, Even Yehuda (IL); Yair LIEBERTHAL, Tel Aviv (IL)

(73) Assignee: Pocoz Israel Ltd, Even Yehuda (IL)

(21) Appl. No.: 17/956,129

(22) Filed: Sep. 29, 2022

(51) Int. Cl. H04L 67/50; G06Q 50/00

(52) U.S. Cl. CPC H04L 67/535; G06Q 50/01

(57) ABSTRACT

Systems and methods of assigning community promoting roles in a virtual computer network of users, including: determining usage of shared information among at least two users sharing information via computers connected by a virtual computer network, assigning at least one community promoting role to at least one user within the virtual computer network of users, wherein the at least one community promoting role is determined based on the determined usage of the shared information, calculating a community contribution score of the at least one user, to the virtual computer network of users, and managing communication traffic in the virtual computer network based on the determined roles.

### FIELD OF THE INVENTION

The present invention relates to computer networks and virtual computer networks of users. More specifically, the present invention relates to managing communications in data networks, and assigning community promoting roles in a network of users.

### BACKGROUND

Computing networks exchanging data among computing systems include social networks, which have become very common so that almost every user of a computing device is associated with, and exchanged data using, at least one social network. Some of these networks are used by a community of users, for instance a community of people sharing a common interest, living in a similar geographical area, etc.

It would therefore be advantageous to utilize technological tools of (e.g. virtual) computer networks, to enhance the cooperation within the community such as sharing information and performing actions together.

### SUMMARY OF THE INVENTION

There is thus provided, in accordance with some embodiments of the invention, a method of assigning community promoting roles in a virtual computer network of users, the method including, using a processor: determining usage of shared information among at least two users sharing information via computers connected by a virtual computer network, assigning at least one community promoting role to at least one user within the virtual computer network of users, wherein the at least one community promoting role is determined based on the determined usage of the shared information, calculating a community contribution score of the at least one user, to the virtual computer network of users, and managing communication traffic in the virtual computer network based on the determined roles.

In some embodiments, the at least one community promoting role is determined based on the determined usage of the shared information via at least one deep machine learning (ML) algorithm. In some embodiments, the at least one deep ML algorithm predicts at least one community promoting role corresponding to the shared information.

In some embodiments, the at least one community promoting role is assigned based on at least one of: user interaction and content of the shared information. In some embodiments, the at least one ML algorithm predicts at least one community promoting role corresponding to the content of the shared information. In some embodiments, the at least one ML algorithm predicts the type of information that is suitable for a particular user of the virtual computer network based on the content of the shared information.

In some embodiments, a task is assigned to at least one user within the virtual computer network based on the assigned at least one community promoting role. In some embodiments, at least one community contribution score is determined within the virtual computer network of users, wherein the at least one community contribution score is determined based on a calculated contribution of the shared information within the virtual computer network of users.

In some embodiments, the shared information is assigned a contribution value based on the assigned at least one community promoting role. In some embodiments, the information is shared within the virtual computer network based on at least one of: the assigned information contribution value and the assigned at least one community promoting role. In some embodiments, the shared information comprises at least one of: a message and a user interaction. In some embodiments, validation of the at least one user interaction is received from at least one other user of the virtual computer network of users.

In some embodiments, at least one user privilege is determined for the at least one user within the virtual computer network of users, wherein the at least one user privilege is determined based on the calculated contribution, wherein managing communication traffic in the virtual computer network is based on the determined privileges.

In some embodiments, network interactions are mapped within the virtual computer network to identify at least one of: communication traffic between at least two users of the virtual computer network, and usage of the shared information among the users of the virtual computer network. In some embodiments, the at least one community promoting role is determined based on the mapped network interactions.

There is thus provided, in accordance with some embodiments of the invention, a device for assigning community promoting roles in a virtual computer network of users, the method including: a memory, and a processor, coupled to the memory, and configured to: determine usage of shared information among at least two users sharing information via computers connected by a virtual computer network, assign at least one community promoting role to at least one user within the virtual computer network of users, wherein the at least one community promoting role is determined based on the determined usage of the shared information, calculate a community contribution score of the at least one user, to the virtual computer network of users, and manage communication traffic in the virtual computer network based on the determined roles.

In some embodiments, the at least one community promoting role is determined based on the determined usage of the shared information via at least one deep machine learning (ML) algorithm. In some embodiments, the at least one ML algorithm predicts at least one community promoting role corresponding to the content of the shared information.

In some embodiments, the processor is configured to determine at least one community contribution score within the virtual computer network of users, and wherein the at least one community contribution score is determined based on a calculated contribution of the shared information within the virtual computer network of users.

In some embodiments, the processor is configured to determine at least one user privilege for the at least one user within the virtual computer network of users, wherein the at least one user privilege is determined based on the calculated contribution, and wherein management of communication traffic in the virtual computer network is based on the determined privileges.

There is thus provided, in accordance with some embodiments of the invention, a method of determining a contribution value for information shared in a virtual computer network of users, the method including, using a processor: identifying at least two users sharing information via computers connected by the network, identifying at least one network interaction for the shared information, wherein the at least one network interaction is identified based on at least one of: communication traffic between at least two users of the virtual computer network, and usage of the shared information among the users of the virtual computer network, and determining a contribution value for the shared information based on the identified at least one network interaction and based on the content of the shared information.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of an exemplary computing device, according to some embodiments of the invention;

FIG. 2 shows a schematic block diagram of a system for assigning community promoting roles in a virtual computer network of users, according to some embodiments of the invention;

FIG. 3A shows data flow to and from the community promoting role, according to some embodiments of the invention;

FIG. 3B shows data flow to and from the member general contribution and the content contribution score, according to some embodiments of the invention; and

FIG. 4 shows a flowchart for a method of assigning community promoting roles in a virtual computer network of users, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

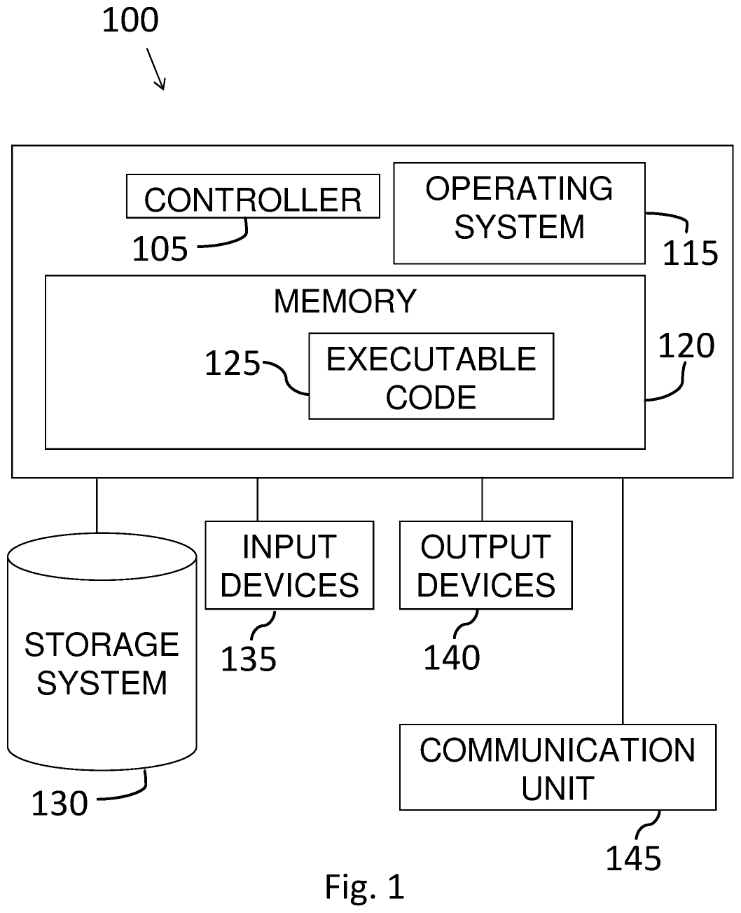

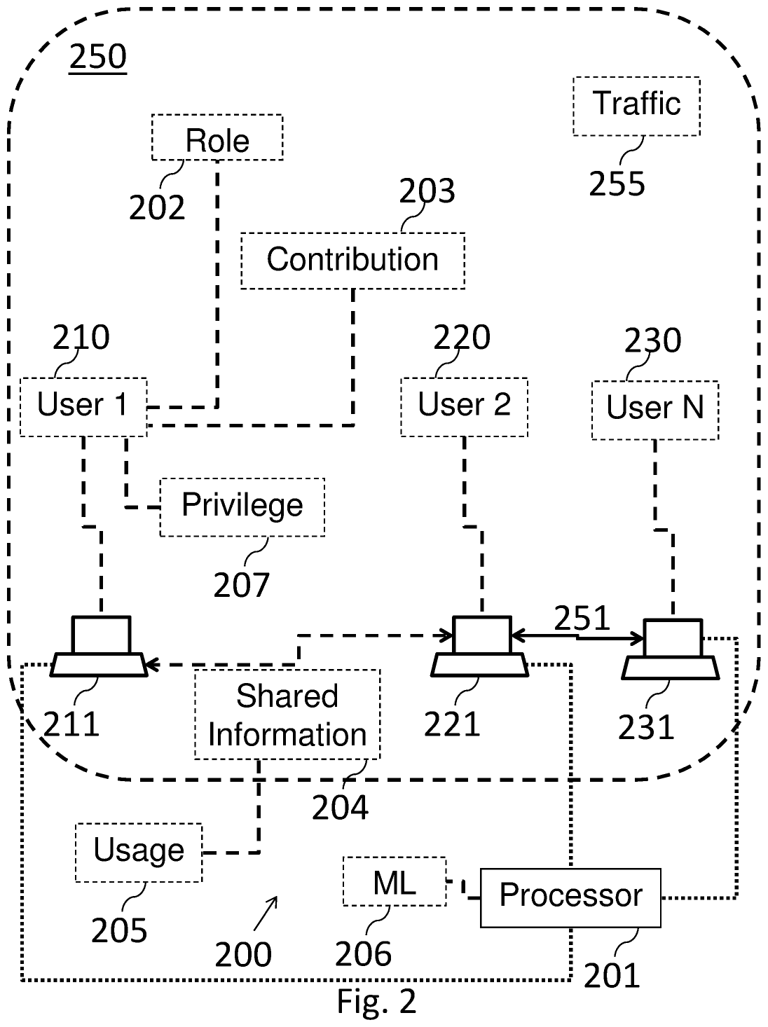

Reference is made to FIG. 1, which is a schematic block diagram of an example computing device, according to some embodiments of the invention. Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet. Controller 105 may be configured to execute program code to perform operations described herein. The system described herein may include one or more computing device(s) 100, for example, to act as the various devices or the components shown in FIG. 2. For example, components of system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets and the like.

Reference is made to FIG. 2, which is a schematic block diagram of a system 200 for managing communications and assigning community promoting roles 202 in a virtual computer network 250 of users, according to some embodiments of the invention. In FIG. 2, hardware elements are indicated with a solid line and the direction of arrows indicate a direction of information flow between the hardware elements.

The virtual computer network 250 may include specific computers, e.g. computing devices 211, 221 and 231, connected by a computer network 251, and thus may be implemented by a physical network, and may include a plurality of users, where each user uses a computing device, such as computing device 100 shown in FIG. 1. For example, a first user 210 of the virtual computer network 250, may use a first computing device 211, a second user 220 may use a second computing device 221, and a user ‘N’ 230 may use Nth computing device 231.

System 200 may include a processor 201 (such as controller 105 shown in FIG. 1) that is coupled to the virtual computer network 250. In some embodiments, the processor 201 is one of the first computing device 211, the second computing device 221, and the Nth computing device 231.

In some embodiments, the processor 201 is coupled to at least one of the first computing device 211, the second computing device 221, and the Nth computing device 231. The processor 201 may analyze communication between the computing devices 211, 221, 231 in order to determine attributes of the users of the virtual computer network 250. The attributes of the users may include community promoting roles and/or privileges within the virtual computer network 250, and/or community contribution scores or other types of community related scores.

According to some embodiments, the system 200 includes a frontend/backend architecture, where the frontend handles a user interface (UI) and user inputs, while the backend handles all the processing such as tracking interactions between users, routing of messages, etc. In such architecture, the processor 201 may be at the backend (e.g., implemented as cloud-based computing) and monitor communication between computers in the network 250.

For example, the processor 201 may identify at least two users 210, 220 sharing information 204 via computers 211, 221 connected by the virtual computer network 250.

In some embodiments, the processor 201 determines usage 205 of the shared information 204 within the virtual computer network 250. For example, the usage 205 may indicate the number of members that interacted with the shared information (e.g., members reading or sharing the information). The shared information may include at least one of a message or a user interaction.

According to some embodiments, the virtual computer network 250 is a social network for a community of users 210, 220, 230, where the group of users or members are working together towards achieving a common goal. For example, a community of people may support the same sports team. A user or member of the community, of the virtual computer network 250, may be assigned, by the processor 201, at least one community promoting role 202 that contributes to the community's success.

In some embodiments, the at least one community promoting role 202 is determined based on the determined usage 205 of the shared information 204. For example, if the usage 205 indicates that a user 220 generates many interactions with other members due to their shared information (e.g., sharing a story on a social network), then that member may be assigned a role of an “Influencer”.

In some embodiments, the processor 201 shares the information within the virtual computer network 250 based on the assigned at least one community promoting role 202. The processor 201 may be configured to manage communication traffic 255 in the virtual computer network 250 based on the determined community promoting roles 202. For example, information from a high ranked user (e.g., with an “Influencer” role) may get priority in sharing via the network compared to other users.

The shared information 204 may be assigned, by the processor 201, a contribution value based on the assigned at least one community promoting role 202. In some embodiments, the processor 201 shares the information within the virtual computer network 250 based on the assigned information contribution value.

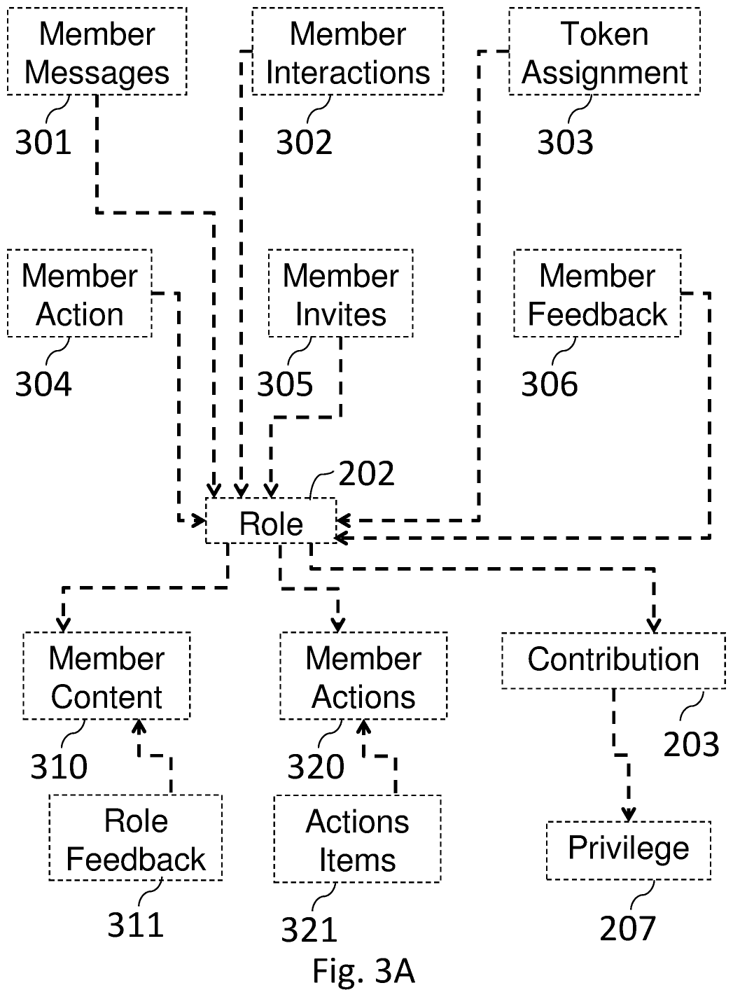

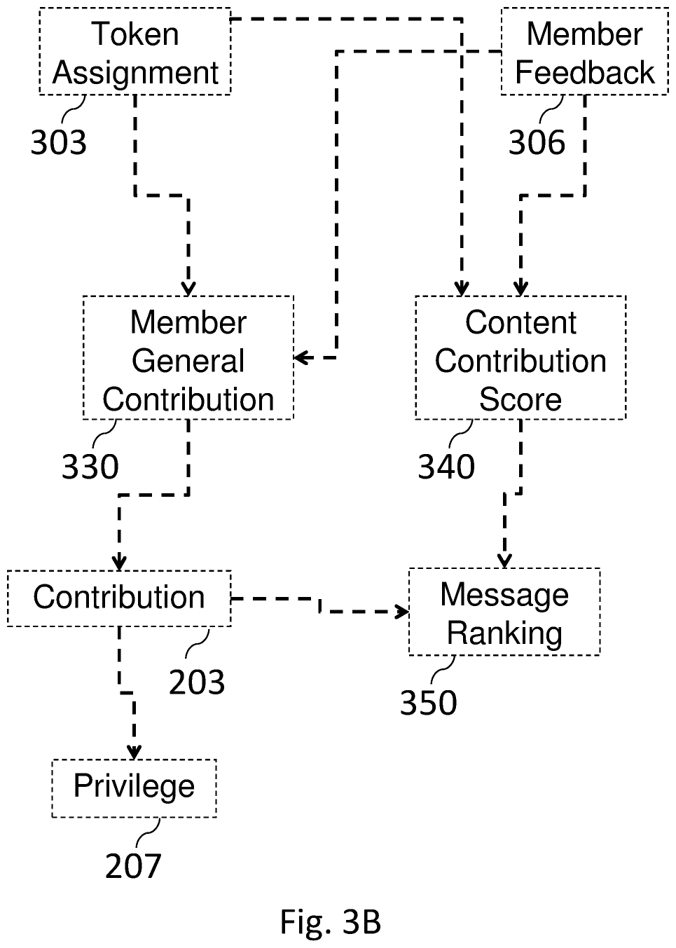

The community promoting role 202 may be selected from the group including: a helper—someone who helps other through advice or actions, and/or a doer—someone who excels at taking action, and/or a communicator—someone who excels at two way communications, a recruiter—some who excels and bringing in new members to the community, a network hub—someone who is very well connected in the community network, and/or a peacemaker—someone who excels at bringing an amicable resolution to a dispute, an influencer—someone who many people turn to for advice and information, and/or a trustee—someone the community trusts, and/or a sage—someone that is considered as experienced and insightful, and/or mentor—someone who excels at mentoring others in the community, and/or a manager—someone who can manage projects, people, resources and tasks, and/or an expert—someone who excels in a certain professional field. For example, for determination of a “Recruitment” role, the processor 201 may keep track and identify members that are invited to the community by other members of the community (such as member invites 305 shown in FIG. 3A).

In some embodiments, a user or member of the community, of the virtual computer network 250, is assigned at least one community contribution score 203 by the processor 201. The community contribution score 203 may include the degree of contribution to the community, and be assigned both to content that is shared between users and also to members in the community.

In some embodiments, other scores are determined by the processor 201, such as a general community contribution score that is based on the degree to which a user of the network 250 and/or content of the shared information 204 is helping the community towards achieving its purpose. The general community contribution score may not be dependent on a specific role 202 but rather on general contribution to the community.

The general community contribution score may be calculated as the sum of contribution scores obtained from the feedback from the user or content received from other users, including tokens and/or content of messages.

The processor 201 may also assign each user of the virtual computer network 250 a role value based on the assigned at least one community promoting role 202. For example, to be assigned a “Helper” role, the role value should be more than 100 Helper points, where each member interaction and/or analysis of shared information may add such points.

The processor 201 may also determine a member community member score, that is calculated as a number reflecting the total contribution of a user or member to the community, taking into account both their community promoting role 202 and their general community contribution score.

The processor 201 may also determine a content community merit score, that is calculated as a number reflecting the contribution of a piece of content (e.g., of the shared information) to the community of the network 250. In some embodiments, the processor 201 analyses content from three sources: member messages, member feedback messages, and assignment of role token of merit by other members of the community. The assignment of role token of merit by other members of the community may include members rewarding other members with a dedicated token of merit.

Reference is made to FIGS. 3A-3B, which data flow between elements of the system 200, according to some embodiments of the invention. Some elements in FIGS. 3A-3B may be similar to corresponding elements in FIG. 2 (e.g., community promoting role 202). The direction of arrows indicate a direction of information flow. FIG. 3A shows data flow to and from the community promoting role 202, and FIG. 3B shows data flow to and from the member general contribution 330 and the content contribution score 340.

In some embodiments, the processor 201 determines and/or assigns the community promoting role 202 based on at least one of: member messages 301, member interactions 302, token assignment 303, members action 304, member invites 305 and member feedback 306. For example, the processor 201 determines the community promoting role 202 based on number of member invites, type of task or member actions within the community and content analysis of member messages.

In some embodiments, the token assignment 303 is determined by members assigning other members with role tokens, for instance based on the contribution of members to the community. For example, when a member notices that another member has been answering a lot of questions, they may have the option to assign them with a “Helper” token. In some embodiments, member privileges 207 determine the number of role tokens each member may assign to other members, and/or the point value (e.g., in the range 25-200) of each token assigned.

In some embodiments, the token assignment 303 is provided to members by the community, where members have the ability to assign other members with contribution tokens (e.g., tokens indicating “Like”, “Amazing work”, “Good Job”, etc.), that is based on the contribution of members to the community. For example, the member privileges 207 may determine the number and/or type of contribution tokens each member may assign.

In some embodiments, the token assignment 303 is provided to the shared information 204 or messaged by the community, where members have the ability to assign messages with contribution tokens, that is based on the contribution of that message to the community. For example, the member privileges 207 may determine the number and/or type of contribution tokens each member may assign.

In some embodiments, member content 310 is determined based on the corresponding community promoting role 202 and feedback 311 from members of the network 250. In some embodiments, tasks or member actions 320 are determined based on the corresponding community promoting role 202 and action items 321.

In some embodiments, the most suitable owner of action items 321 is determined based on the assigned community promoting role 202. The action items 321 may be categorized by their creator to a certain type of role. Once an action item, that has been assigned to a role, has been created, the processor 201 may be able to match this action item to a person that has those roles assigned. In case where more than one member is suitable for the action item the processor 201 may assign the role to the to the person with highest community contribution score. In addition, the creator of the action item may be able to define other screening criteria for assignees such as geographical location, professional skills and more.

In some embodiments, member general contribution 330 is determined based on at least one of: token assignment 303 and/or member feedback 306. In some embodiments, content contribution score 340 is determined based on at least one of: token assignment 303 and/or member feedback 306.

In some embodiments, the member feedback 306 includes at least one of message contribution feedback to other members and/or message contribution feedback to other messages. The processor 201 may identify members of the network 250 that show appreciation to a member's contribution and/or message's contribution by making positive statements about the members in messages that corresponds to that member and/or message contribution. For example, the processor 201 may identify that a member wrote a post about a new idea, they had that can help the community reduce costs, another member may respond with a comment “This is a great idea. I think we should implement it ASAP!” so that the initial message may be identified as a contributing message.

The received messages may be analyzed to identify correlations between various statements within those messages and members contribution, for instance via a supervised machine learning-natural language processing (ML-NLP) model, as further described hereinafter. Examples for messages that include contribution statements are: “Thank you so much for everything” or “So glad to have you with us”.

The contribution tokens assigned to a message may add both to the content contribution score 340 of the specific message and/or to the member general contribution 330 of the author of the message that received the positive feedback.

The member general contribution 330 may be determined (e.g., by the processor 201) using community structured and unstructured feedback, as the degree to which each member is generally contributing to the community In contrast to the community contribution score 203, the member general contribution 330 may be determined based on the feedback that cannot be mapped to a particular role the member is playing in the community, but to their general contribution to the community. For example, when the processor 201 identifies that a member tells another member (e.g., in a message intercepted by the processor 201) “You are amazing!” it may be identified (e.g., using machine learning algorithm to analyze content of the shared information) that that person is positively affecting another member, although it cannot be attributed to a particular role.

In some embodiments, message ranking 350 is determined based on at least one of: content contribution score 340 and/or the community contribution score 203.

The community message ranking 350 may be determined (e.g., by the processor 201) as the order in which messages are displayed in the general content feed of the community of network 250. Thereby ensuring that content that is most constructive may be presented at the top of the feed for shared information 204. The ranking may be based on for example three inputs: the time of posting the message: where more recent content may receive priority; and/or the community contribution score 203 of the member posting the message: where members with a higher community contribution score may receive priority; and/or the content contribution score 340 of the message being posted.

According to some embodiments, the processor 201 may be configured to manage communication traffic 255 in the virtual computer network 250 based on the content, where shared information with high usage (e.g., shared between a plurality if users) may be managed with a higher visibility.

The community contribution score 203 and/or the content contribution score 340 may be aggregated to calculate a message overall merit score (e.g., with the content contribution score 340 having a weight of 0.99 and the community contribution score 203 having a weight of 0.01).

According to some embodiments, input from at least one of the following elements is used for prediction by a machine learning algorithm (as further described hereinafter): member messages 301, member interactions 302, member feedback 306, and role feedback 311.

Returning now back to FIG. 2. The community promoting role 202 and/or community contribution score 203 may be determined based on a variety of inputs. Some of these inputs or signals may be manually determined, some rule based, some based on deep machine learning, and some using network graphs.

These inputs may include self-indicative signals and/or feedback signals and/or interaction signals, for instance identified based on content analysis of the shared information 204. The interaction signals may be determined from at a member interaction with other members, for instance using network analysis techniques. Some of these inputs may be used as part of a learned machine learning model and some may be used as algorithmic rules. In some embodiments, at least one machine learning algorithm may be employed to analyze the content of the member messages in order to identify indication of a community promoting role 202.

Each signal may provide the member with a defined number of “role points”. Role points per member from the various inputs may be aggregated to determine the members' total number of role points, for instance per role.

For example, the community contribution score 203 may be calculated for each member by adding together the sum of total role points and the sum of total member contribution points. This number may reflect the total contribution of the member to the community and may be used as one of the inputs to content feed ranking and/or member privileges.

For example, a minimal number of 100 role points may be required to consider a member truly filling one of those community promoting roles 202. A member may receive these points from various signals: 35 “Helper” points from a 1^{st} signal, 25 “Helper” points from a 2^{nd} signal, 40 “Doer” points from a 3^{rd} signal, 50 “Doer” points from a 4^{th} signal, and 30 “Doer” points from a 5^{th} signal so in total there are 60 “Helper” points (not qualifying as a community “Helper” as still under the 100 points threshold, and 120 “Doer” points—qualifying as a “Doer” as its above the 100 points threshold.

The member messages may include communication between users or members (e.g., as in shared information 204), that may assist determining the role that these members play. These could be messages such as: “let me help you with that” for someone who is assigned a “Helper” role; “lets try and find a resolution to this” to someone who is assigned a “Peacemaker” role, or “I will do it” for someone who is assigned a “Doer” role. For example, a member message with a role indication may grant that member 10 points (e.g., a unitless value intended to assign a weight to each contribution within the community) within the network 250.

According to some embodiments, a supervised machine learning-natural language processing (ML-NLP) model 206 is used to predict which shared information 204 by a member indicate that they correspond to one of the community promoting roles 202. The inputs to the ML-NLP model 206 may be messages (such as member messages 301 shown in FIG. 3A) by a member immediately before, for instance in previous 24 hours, they received a role token from another member in the community. The categories (or labels) that may be learned are: Helper; Doer; Trustee; Peacemaker; Mentor; Sage; Manager; Expert. Using topic classification techniques, the learned model may identify correlations between user statements within the shared information 204 and community promoting roles 204 that were assigned for them. For example, it is expected that members that frequently make statements such as “let me help you with that” are likely to be identified as “Helpers” by the community.

During the initial stages, as the ML-NLP model 206 learns and improves, the processor 201 may initially validate its predictions by asking a predefined group of members (e.g., influencers) that are familiar with a particular member whether they agree that that member should indeed receive a particular community promoting role.

The processor 201 may use the at least one (deep) ML algorithm 206 to predict at least one community promoting role 202 corresponding to the shared information 204. Once the accuracy rate of these validations passes a threshold, e.g. above 90%, of the cases the ML-NLP model 206 may predict autonomously without the need for additional validations. For example, once a message is identified and verified that member may receive 10 role points.

In some embodiments, the at least one (deep) ML algorithm 206 receives as input the shared information 204 (e.g., messages of members) and/or labels. The messages may include information about themselves and about others. The labels may be the community promoting roles that members assigned to other members. Thus, the ML algorithm 206 may learn how to predict labels based on the received shared information 204.

In some embodiments, the at least one community promoting role 202 is assigned based on content of the shared information 204, for instance the content may be determined by the ML-NLP model 206. For example, if the content of a message is positive towards another member, then the ML-NLP model 206 predicts a corresponding role.

In some embodiments, the at least one deep ML algorithm 206 predicts the type of information that is suitable for a particular member of the virtual computer network 250 based on the content of the shared information 204. For example, analyzing the content to determine that a particular member creates more interaction with this type of content.

In some embodiments, the processor 201 utilizes network analysis to analyze traffic 255 with member interactions (such as member interactions 302 shown in FIG. 3A) including member connections and communications to predict at least one of the following roles: “Communicator”; “Influencer”; “Network Hub” and “Recruiter”. The Communicator is someone whose involvement in receiving content and passing on content is in the top 10% of the communication traffic of the community within the network 250. The Network Hub is someone who has a large number of community connections (or links) so that they are in the top 10% if network connections in that community of network 250. The Influencer is a member who shares content that is then further shared, on average, by others ×10 more than the average rate of sharing info in the community.

In some embodiments, interactions or links include one or more interaction between two members in the community of network 250. For example, a one on one direct message, a comment in response to a message, and/or being assigned an action created by a member.

In some embodiments, role feedback (such as feedback 311 shown in FIG. 3A) may be employed. In addition to the role tokens that the community is able to assign to a member playing a positive role in the community, members of network 250 may also be able to show appreciation to a members' role by making positive statements in messages that may be tied to that member roles.

The processor 201 may use the ML-NLP model 206 to analyze such role feedback messages, and through a supervised learning method (again using the assigned role tokens as the labels) the processor 201 may identify correlations between various statements within those messages and member roles. For example, in a direct message like “Hi Tim. You did a great job reducing the tension in the discussion with Joe and Jane and helping us find a resolution”, the term “great job reducing the tension” may be identified as a strong indicator to a “Peacemaker” role. Another example could be a comment such as “thank you for being someone I could really trust during hard times” where the term “could really trust” may be identified as a strong indicator to a “Trustee” role.

As the ML-NLP model 206 learns and improves, the processor 201 may initially validate its predictions by asking the message author whether they agree that person should indeed receive a particular role points. Once the accuracy rate of validations passes 90% of the cases the processor 201 may make predictions autonomously without the need to validate. For example, once a message is identified and verified as an indicator of a role the member may receive 20 role points.

The self-indicative signals may be determined directly from member actions within the community (e.g., generating a spreadsheet to manage budget) and/or analysis of messages' content, that indicate that a member has filled one of the community promoting roles and/or has generally contributed to the community. These self-indicative signals may be generated without the need to receive additional feedback from the community.

In some embodiments, members of the network 250 may setup various member actions (such as member actions 320 shown in FIG. 3A). For example, member actions may include exchanging information between users of the computing devices 211, 221, 231 for publishing various content on social media, creating a spreadsheet to manage budget, volunteering to organize an event for the community and the like. User 1 may send a message to user 2, for example from computing device 211 to computing device 221, with a request for an action.

According to some embodiments, the processor 201 may be configured to manage communication traffic 255 in the virtual computer network 250 based on the tasks or member actions. For example, a particular helping task may be routed and/or assigned to members of “helper” role.

As part of creating these actions, the member generating the action may determine which type of community promoting role 202 is best suited to be assigned to the action, and the number of role points the action is worth (e.g., in the range of 10-30 points). For example, publishing various content is best suited for a “Communicator”, creating a spreadsheet is best suited for a “Sage”, and volunteering to organize an event is best suited for a “Doer”. Once a member is assigned to these actions, and reports that it's completed (e.g., to be confirmed by the creator of the action), the assignee member may automatically receive the role points that are assigned to that action.

The feedback signals may be determined from the way members response to other members actions and/or messages, as well as to the members themselves. For example, feedback signals may include tokens that are assigned to a particular member and/or message and/or action of the community. In another example, the feedback signals may include determining (e.g., by analyzing content by the processor 201) that a member message indicates that they appreciate that another member has filled a positive role or generally contributed them.

In some embodiments, messages that are sent between users of the network 250 (e.g., via computing devices 211, 221, 231) may include various types of communication. For example, posts with general messages from members, comments with responses of members to posts, ideas with various suggestions of members, questions/answers, and direct messages.

The member feedback messages may include communication between users or members (e.g., as in shared information 204), for instance what members say about other members that may help determine the role 202 of the other person. For example, the phrase “you have been very helpful” may be provided as feedback on someone who is a “Helper”. Another example is feedback such as “you are a real mentor” on someone who is a “Mentor”. Another example is feedback such as “you are such an expert” on someone who is an “Expert”. A member feedback message with a role indication may grant the person receiving the feedback with 20 points.

According to some embodiments, the processor 201 determines at least one member privilege 207 as activities each member may be entitled to perform in the network 250. For example, the at least one member privilege 207 may correspond to the number and/or value (e.g., in the range 25-200) of tokens that each member may assign to other members. The at least one user privilege 207 may be determined based on the assigned at least one community promoting role 202.

In some embodiments, the at least one member privilege 207 is determined according to a tier the member belongs to. Each tier may include a different set of privileges for members assigned to this tier.

Tiers may be established with each tier requiring a different number of minimal points. Each tier may have a definition of the various activities the members are allowed to perform and the number of role and contribution tokens they may be allowed to allocate to other members.

In some embodiments, the processor 201 determines at least one user privilege 207 for the at least one user within the virtual computer network 250, where the at least one user privilege 207 is determined based on the calculated community contribution score 203. In some embodiments, the processor 201 manages communication traffic 255 in the virtual computer network 250 based on the determined privileges 207.

According to some embodiments, the processor 201 maps network interactions within the virtual computer network 250 to identify at least one of: communication traffic 255 between at least two users of the virtual computer network 250, and/or usage 205 of the shared information 204 among the users of the virtual computer network 250. The at least one community promoting role 202 may be determined based on the mapped network interactions.

Certain roles such as “Communicator” (e.g., users that are good at receiving content e.g. post, link and forwarding it to many other people), “Network Hub” (e.g., users that communicate with many users in the network), “Influencer” (e.g., a user that shares content that is then further shared, on average, by others ×10 more than the average rate of sharing info in the community) and “Recruiter” may be learned or detected from the way the users generally interact with other users without the need to analyze the specific content they are using in communication, or the feedback they receive. For example, knowledge graph techniques may be used.

According to some embodiments, members are able to have a personalized view of the community content, using the ML-NLP model 206. The ML-NLP model 206 may learn what content is most suitable to a particular member by mapping members to content they find contributing. Another advantage of this solution is the ability to track for each member the messages that they provided positive feedback on, in the form of role tokens, contribution tokens, and unstructured feedback.

In order to determine content personalization, role feedback 311 may be received from members that are closest to the member (for content personalization) within the community of network 250. The closest members may include members the member is connected to and also members that fill the same role as the member. Content that these members find contributing may be considered contributing to the member as well. After training, the ML-NLP model 206 may predict whether a piece of content that these members find as contributing to the community, may also be found contributing by the member using at least one following signals: the number of a members that provide positive feedback to a message, and/or the strength of positive feedback each member makes to that message, for instance measured by the number of contribution points assigned by them to that message. Based on these signals, each pair of message and member may have a content matching score (e.g., as a score from 0-1 that represents to what degree a specific member is likely to find interest in this message). Members that choose to see a personalized view of their messages may only see messages that have received a content matching score of above 0.9, by default. The order of messages within their personalized view may continue to be ordered by message ranking 350.

According to some embodiments, the processor 201 may be configured to manage communication traffic 255 in the virtual computer network 250 based on the personalized content where each member receives a personalized view.

According to some embodiments, the processor 201 determined member recommendation(s) in order to improve the connections between members of the network 250. Thus, the processor 201 may suggest new connection to a particular member, for instance based on member similarity features. For example, members that have similar roles and/or similar contribution scores may be recommended to one another.

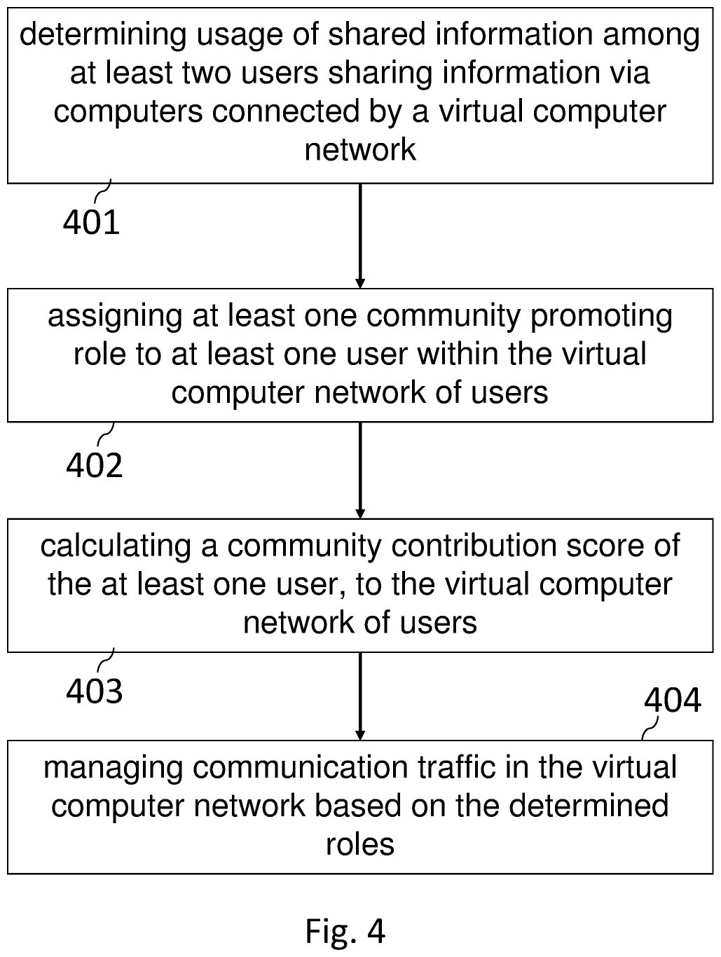

Reference is made to FIG. 4, which is a flowchart for a method of assigning community promoting roles in a virtual computer network of users, according to some embodiments of the invention.

In operation 401, usage of shared information among at least two users sharing information via computers connected by a virtual computer network is determined.

In operation 402, at least one community promoting role is assigned to at least one user within the virtual computer network of users. In some embodiments, the at least one community promoting role is determined based on the determined usage of the shared information.

In operation 403, a community contribution score is calculated of the at least one user, to the virtual computer network of users. In operation 404, communication traffic is managed in the virtual computer network based on the determined roles.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of assigning community promoting roles in a virtual computer network of users, the method comprising, using a processor:
determining usage of shared information among at least two users sharing information via computers connected by a virtual computer network;
assigning at least one community promoting role to at least one user within the virtual computer network of users, wherein the at least one community promoting role is determined based on the determined usage of the shared information;
calculating a community contribution score of the at least one user, to the virtual computer network of users; and
managing communication traffic in the virtual computer network based on the determined roles.

2. The method of claim 1, wherein the at least one community promoting role is determined based on the determined usage of the shared information via at least one deep machine learning (ML) algorithm.

3. The method of claim 2, wherein the at least one deep ML algorithm predicts at least one community promoting role corresponding to the shared information.

4. The method of claim 2, wherein the at least one community promoting role is assigned based on at least one of: user interaction and content of the shared information.

5. The method of claim 6, wherein the at least one ML algorithm predicts at least one community promoting role corresponding to the content of the shared information.

6. The method of claim 6, wherein the at least one ML algorithm predicts the type of information that is suitable for a particular user of the virtual computer network based on the content of the shared information.

7. The method of claim 1, further comprising assigning a task to at least one user within the virtual computer network based on the assigned at least one community promoting role.

8. The method of claim 1, further comprising determining at least one community contribution score within the virtual computer network of users, wherein the at least one community contribution score is determined based on a calculated contribution of the shared information within the virtual computer network of users.

9. The method of claim 1, further comprising assigning the shared information a contribution value based on the assigned at least one community promoting role.

10. The method of claim 9, further comprising sharing the information within the virtual computer network based on at least one of: the assigned information contribution value and the assigned at least one community promoting role.

11. The method of claim 1, wherein the shared information comprises at least one of: a message and a user interaction.

12. The method of claim 11, further comprising receiving, from at least one other user of the virtual computer network of users, validation of the at least one user interaction.

13. The method of claim 1, further comprising determining at least one user privilege for the at least one user within the virtual computer network of users, wherein the at least one user privilege is determined based on the calculated contribution, wherein managing communication traffic in the virtual computer network is based on the determined privileges.

14. The method of claim 1, further comprising mapping network interactions within the virtual computer network to identify at least one of:
communication traffic between at least two users of the virtual computer network; and
usage of the shared information among the users of the virtual computer network,
wherein the at least one community promoting role is determined based on the mapped network interactions.

15. A device for assigning community promoting roles in a virtual computer network of users, the device comprising:
a memory; and
a processor, coupled to the memory, and configured to:
determine usage of shared information among at least two users sharing information via computers connected by a virtual computer network;
assign at least one community promoting role to at least one user within the virtual computer network of users, wherein the at least one community promoting role is determined based on the determined usage of the shared information;
calculate a community contribution score of the at least one user, to the virtual computer network of users; and
manage communication traffic in the virtual computer network based on the determined roles.

16. The device of claim 15, wherein the at least one community promoting role is determined based on the determined usage of the shared information via at least one deep machine learning (ML) algorithm.

17. The device of claim 16, wherein the at least one ML algorithm predicts at least one community promoting role corresponding to the content of the shared information.

18. The device of claim 15, wherein the processor is configured to determine at least one community contribution score within the virtual computer network of users, and wherein the at least one community contribution score is determined based on a calculated contribution of the shared information within the virtual computer network of users.

19. The device of claim 15, wherein the processor is configured to determine at least one user privilege for the at least one user within the virtual computer network of users, wherein the at least one user privilege is determined based on the calculated contribution, and wherein management of communication traffic in the virtual computer network is based on the determined privileges.

20. A method of determining a contribution value for information shared in a virtual computer network of users, the method comprising, using a processor:
identifying at least two users sharing information via computers connected by the network;
identifying at least one network interaction for the shared information, wherein the at least one network interaction is identified based on at least one of:
communication traffic between at least two users of the virtual computer network; and
usage of the shared information among the users of the virtual computer network; and
determining a contribution value for the shared information based on the identified at least one network interaction and based on the content of the shared information.
